(19) United States
(12) Patent Application Publication
(10) Pub. No.: US 2024/0119539 A1
(43) Pub. Date: Apr. 11, 2024

(54) INFERRING AND CONTEXTUALIZING A STRANGER ON AN ENTERPRISE PLATFORM

(71) Applicant: Microsoft Technology Licensing, LLC, Redmond, WA (US)

(72) Inventors: Mohammadreza BONYADI, Trondheim (NO); Eivind Berg FOSSE, Oslo (NO); Sergey PUTILIN, Oslo (NO); Espen Trautmann SOMMERFELT, Oslo (NO); Ute Katja SCHIEHLEN, Oslo (NO); Kateryna SOLONKO, Oslo (NO); Ola SAETROM, Oslo (NO); Torbjørn HELVIK, Oslo (NO); Malgorzata PARUCH, Oslo (NO)

(21) Appl. No.: 18/067,010

(22) Filed: Dec. 15, 2022

Related U.S. Application Data
(60) Provisional application No. 63/378,510, filed on Oct. 5, 2022.

(51) Int. Cl. G06Q 50/00; G06N 5/04

(52) U.S. Cl. CPC G06Q 50/01; G06N 5/04

(57) ABSTRACT

Systems and methods for inferring and contextualizing a stranger on an enterprise platform are provided. The method includes generating a familiarity score between a user and an individual. Based on the generated familiarity score, the individual is determined to be a stranger to the user and a contextualized summary of the stranger is generated. The generated contextualized summary of the stranger is presented to the user in response to an upcoming interaction between the user and the stranger or a detected interaction between the user and the stranger.

### CROSS-REFERENCE TO RELATED APPLICATION(S) AND CLAIM OF PRIORITY

This application claims priority to U.S. Provisional Patent Application No. 63/378,510 entitled “INFERRING AND CONTEXTUALIZING A STRANGER ON AN ENTERPRISE PLATFORM” filed on Oct. 5, 2022. The above-identified provisional patent application is hereby incorporated by reference in its entirety.

### BACKGROUND

Individuals, including employees, independent contractors, and executives, working in organizations of all sizes often meet and interact with strangers in the course of their day-to-day activities. Strangers may include other members of the organization or individuals outside the organization with whom the individual has not previously interacted with or has had such minimal interactions with that the individual is unfamiliar with the other person. Unfamiliarity with a person, their background, and their position within the organization or otherwise, impacts the style and context of the communication an individual may have with them. In some cases, due to the large number of potential strangers an individual interacts with on a day-to-day basis, it may be difficult to sufficiently contextualize every stranger prior to or immediately following an interaction.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A system and computerized method for inferring and contextualizing a stranger on an enterprise platform is provided. The computerized method includes generating a familiarity score between a user and an individual, determining that the individual is a stranger to the user based on the generated familiarity score, generating a contextualized summary of the stranger, and presenting the generated contextualized summary of the stranger to the user.

### BRIEF DESCRIPTION OF THE DRAWINGS

The present description will be better understood from the following detailed description read in light of the accompanying drawings, wherein:

FIG. 1A is a block diagram illustrating a system for inferring and contextualizing a stranger on an enterprise platform according to examples of the present disclosure;

FIG. 1B is a system diagram illustrating a system for inferring and contextualizing a stranger on an enterprise platform according to examples of the present disclosure;

FIG. 2 is a computerized method of inferring and contextualizing a stranger on an enterprise platform according to examples of the present disclosure;

FIG. 3 is a computerized method of generating a feed including one or more contextualized strangers according to examples of the present disclosure;

FIG. 4A is an example of a generated feed including one or more contextualized strangers according to examples of the present disclosure;

FIG. 4B is an example of a generated feed including one or more contextualized strangers according to examples of the present disclosure;

FIG. 5 is an example of a ranking annotation according to examples of the present disclosure;

FIG. 6 is a computerized method of inferring and facilitating reestablishment of a relationship according to examples of the present disclosure;

FIG. 7 is an example of a generated feed including one or more relationships for reestablishment according to examples of the present disclosure; and

FIG. 8 is a block diagram of an example computing device for implementing examples of the present disclosure.

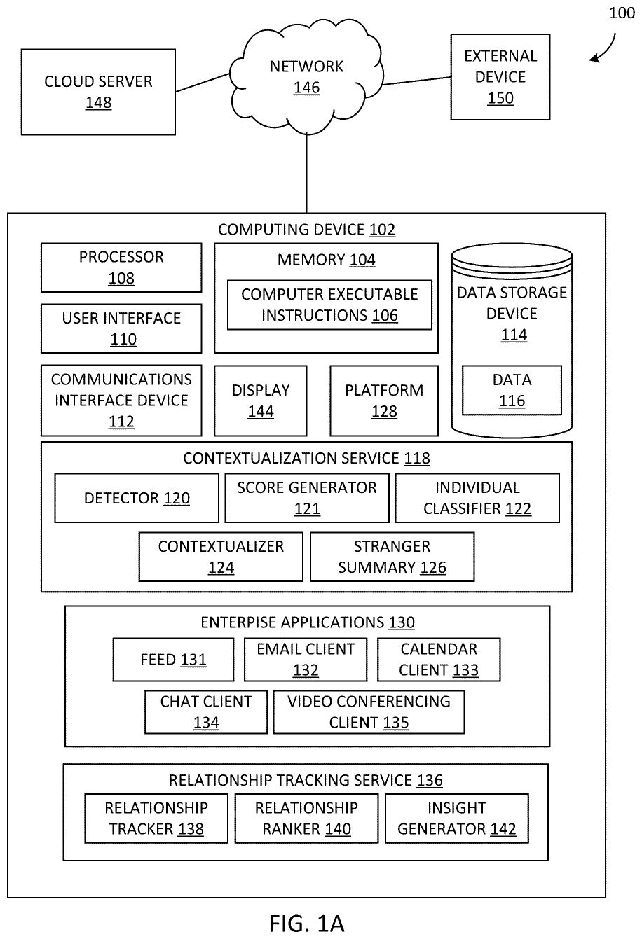

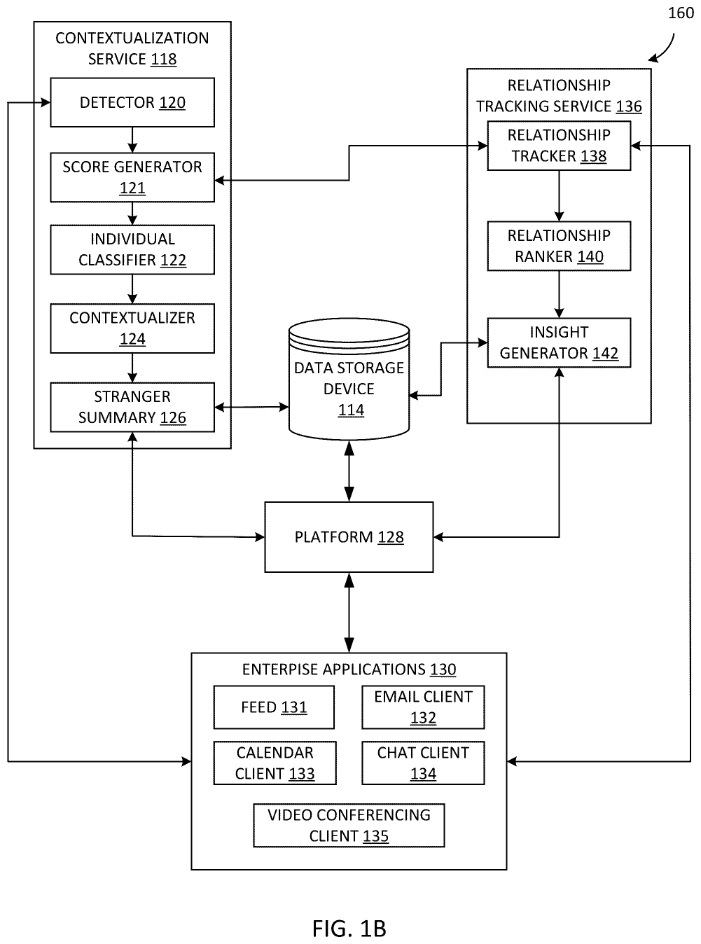

Corresponding reference characters indicate corresponding parts throughout the drawings. In FIGS. 1A-8 the systems are illustrated as schematic drawings. The drawings may not be to scale.

### DETAILED DESCRIPTION

As described herein, it may be difficult to sufficiently contextualize every stranger prior to or immediately following an interaction due to the large number of potential strangers an individual interacts with on a day-to-day basis. For example, a management-level individual typically has between ten and twenty meetings per week. If one-third of those meetings include a large pool of attendees and one-fifth of those meetings include at least one stranger, then the management-level individual is likely to have at least one meeting per week with at least one stranger to them. Rather than being able to spend the meeting fully absorbed in the substantive aspects of the meeting, the individual may spend at least part of the meeting manually attempting to identify and contextualize the stranger, which is time that otherwise would be spent on the substantive aspects of the meeting.

Current solutions are not equipped to appropriately contextualize strangers for an individual. For example, current solutions require users to manually review electronic mail (e-mail), lists of attendees for upcoming calendar events, and so forth in order to identify strangers, then manually attempt to identify the stranger. These solutions are time intensive and fail to provide all the relevant information for a particular stranger, much less all strangers in a given meeting or day.

The examples described herein recognize and take into account the insufficiencies of the present solutions, and provide contextualization systems and methods to connect to various clients, such as email application clients, calendar application clients, chat application clients, video conferencing application clients, and so forth, in order to identify strangers that a user will or has interacted with, contextualize the stranger for the user, generate insights regarding the contextualized stranger, and export the generated insights regarding the contextualized stranger to an enterprise platform. The generated insights are presented for viewing and interaction with by the user on a user device, such as a mobile electronic device, a laptop computer, a tablet, a wearable electronic device, or an augmented reality (AR) or virtual reality (VR) device. The generated insights may be presented by a particular client application, such as by one or more of the email application client, calendar application client, chat application client, video conferencing application client, and so forth, or in a feed of the enterprise platform described herein. By contextualizing the stranger for the user and presenting generated insights regarding the contextualized stranger, in particular, content presented to the user is tailored to the user's previous interactions, or lack thereof, with the stranger to the user identified in an upcoming event or a stranger to the user that the user has recently interacted with.

The examples described herein further provide prediction systems and methods that connect the contextualization systems to the enterprise platform. By implementing a separate platform that connects the contextualization system to the enterprise platform, the contextualization is enabled to provide a singular contextualization service that takes into account strangers identified by data obtained from multiple client applications For example, the utilization of the prediction system enables the contextualization system to take into account interactions across multiple clients to determine whether an external individual is a stranger or not, rather than identifying strangers from one client data source separately than strangers from another client data source. The prediction system further converts the raw data generated by the contextualization system to specific formats and standards for individual clients for presentation. Accordingly, the prediction system transforms raw data into a specific format compatible with a particular client, to be presented by the specific client, such as an email application client, a calendar application client, a chat application client, a video conferencing application client, a social feed client, and so forth, optimizing the delivery of the content generated by the contextualization system and tailoring the generated content to the particular user and user device which receives the generated content.

The examples described herein further provide systems and methods that infer and re-establish deteriorating relationships between individuals. The systems determine a collaboration strength between individuals to determine an intensity of collaboration, and as the intensity is determined to be decreasing over time, provide a mechanism to enable re-establishment of the relationship. Accordingly, the systems tailor the generated content to a particular working relationship that is presented to one or both parties of the relationship in the specific format for the particular user and user device which receives the generated content.

FIG. 1A is a block diagram illustrating a system for inferring and contextualizing a stranger on an enterprise platform according to examples of the present disclosure. The network environment 100 illustrated in FIG. 1A is provided for illustration only. Other examples of the network environment 100 can be used without departing from the scope of the present disclosure.

The network environment 100 includes a computing device 102, an external device 150, and a cloud server 148. Each of the computing device 102, the external device 150, and the cloud server 148 are communicatively coupled to and communicate via a network 146. The computing device 102 represents any device executing computer-executable instructions 106 (e.g., as application programs, operating system functionality, or both) to implement the operations and functionality associated with the computing device 102. The computing device 102, in some examples, includes a mobile computing device or any other portable device. A mobile computing device includes, for example but without limitation, a mobile telephone, laptop, tablet, computing pad, netbook, gaming device, wearable device, Internet of Things (IoT) device, and/or portable media player. The computing device 102 can also include less-portable devices such as servers, desktop personal computers, kiosks, IoT devices, or tabletop devices. Additionally, the computing device 102 can represent a group of processing units or other computing devices. In some examples, the computing device 102 is a device executed in the cloud.

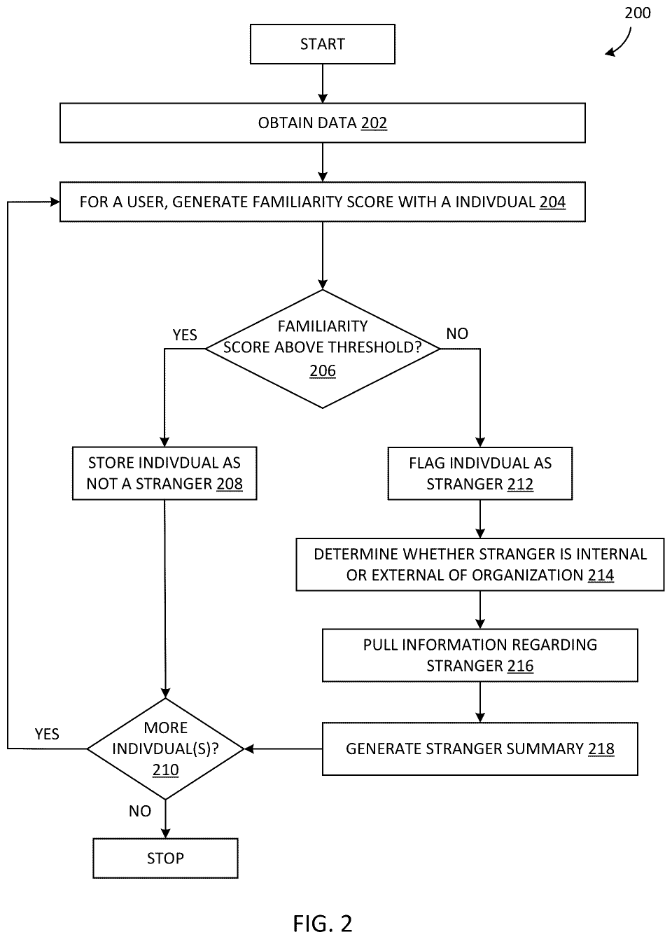

In some examples, the computing device 102 includes at least one processor 108, a memory 104 that includes the computer-executable instructions 106, a user interface 110, and a display 144. The processor 108 includes any quantity of processing units, including but not limited to a central processing unit (CPU) or units, a graphics processing unit (GPU) or units, and a neural processing unit (NPU) or units. The processor 108 is programmed to execute the computer-executable instructions 106. The computer-executable instructions 106 are performed by the processor 108, performed by multiple processors within the computing device 102, or performed by a processor external to the computing device 102. In some examples, the processor 108 is programmed to execute computer-executable instructions 106 such as those illustrated in the figures described herein, such as FIGS. 2-8.

In various examples, the processor 108 is configured to execute a contextualization service 118, a platform 128, enterprise applications 130, and a relationship tracking service 136 as described in greater detail below. In other words, the contextualization service 118, the platform 128, the enterprise application 130, and the relationship tracking service 136 are implemented on and/or by the processor 108. In some examples, one or more of the contextualization service 118, the platform 128, the enterprise applications 130, and the relationship tracking service 136 operate remotely from the computing device 102. For example, one or more of the contextualization service 118, the platform 128, the enterprise applications 130, and the relationship tracking service 136 may be deployed in the cloud or in a distributed manner and accessed as software as a service (SaaS).

The memory 104 includes any quantity of media associated with or accessible by the computing device 102. The memory 104 in these examples is internal to the computing device 102, as illustrated in FIG. 1A. In other examples, the memory 104 is external to the computing device 102 or both internal and external to the computing device 102. For example, the memory 104 can include both a memory component internal to the computing device 102 and a memory component external to the computing device 102. The memory 104 stores data, such as one or more applications. The applications, when executed by the processor 108, operate to perform various functions on the computing device 102. The applications can communicate with counterpart applications or services, such as web services accessible via the network 146. In an example, the applications represent downloaded client-side applications that correspond to server-side services executing in a cloud, such as the cloud server 148.

The user interface 110 includes a graphics card for displaying data to a user and receiving data from the user. The user interface 110 can also include computer-executable instructions, for example a driver, for operating the graphics card. Further, the user interface 110 can be presented on the display 144, for example a touch screen display or natural user interface, and/or include computer-executable instructions, for example a driver, for operating the display 144. In some examples, the user interface 110 enables the user to select a network protocol to utilize for executing cross-device communication. The user interface 110 can also include one or more of the following to provide data to the user or receive data from the user: speakers, a sound card, a camera, a microphone, a vibration motor, one or more accelerometers, a BLUETOOTH® brand communication module, global positioning system (GPS) hardware, and a photoreceptive light sensor. In a non-limiting example, the user inputs commands or manipulates data by moving the computing device 102 in one or more ways.

The computing device 102 further includes a communications interface device 112. The communications interface device 112 includes a network interface card and/or computer-executable instructions, such as a driver, for operating the network interface card. Communication between the computing device 102 and other devices, such as but not limited to the cloud server 148, can occur using any protocol or mechanism over any wired or wireless connection.

The computing device 102 further includes a data storage device 114 for storing data, such as, but not limited to data 116. The data storage device 114 in some non-limiting examples includes a redundant array of independent disks (RAID) array. In some examples, the data 116 is data stored regarding interactions between a user in an organization and one or more other individuals in the organization. The data 116 is utilized by one or more aspects of the contextualization service 118, such as a detector 120 and a contextualizer 124, and sent to the data storage device 114 for storage. In some examples, the data 116 is converted from a raw data format to a client-specific format by the platform 128 for presentation to the user on one or more enterprise applications 130. In some examples, the data 116 is used by the relationship tracking service 136 to track the intensity of working relationships between individuals, track trends in the intensity of the working relationships, and, in some examples, enable opportunities or generate insights to reestablish relationships between individuals that are trending down in intensity. In some examples, the data 116 is organization-specific and includes an organization chart detailing different teams within the organization, historical data regarding project staffing, and so forth.

The data storage device 114, in this example, is included within the computing device 102, attached to the computing device 102, plugged into the computing device 102, or otherwise associated with the computing device 102. In other examples, the data storage device 114 includes a remote data storage accessed by the computing device 102 via the network 146, such as a remote data storage device, a data storage in a remote data center, or a cloud storage.

The computing device 102 includes a contextualization service 118 that is implemented on the processor 108. The contextualization service 118 includes a detector 120, a score generator 121, an individual classifier 122, and a contextualizer 124. Each of the detector 120, the score generator 121, the individual classifier 122, and the contextualizer 124 may be referred to as specialized processing units implemented on the processor 108 that perform specialized processing functions.

The detector 120 interacts with one or more client plug-ins, such as an application programming interface (API), to obtain data from one or more enterprise applications 130. For example, the detector 120 obtains, or scrapes, data from respective enterprise applications 130. In some examples, the detector 120 wakes and obtains the data at a regular interval, such as every hour, every two hours, every twelve hours, or every day. In some examples, the detector 120 continuously obtains data from the enterprise applications 130 in real time. The enterprise applications 130 include a feed 131, an email client 132, a calendar client 133, a chat client 134, and a video conferencing client 135. However, these examples should not be construed as limiting. More or fewer clients may be included as enterprise applications 130 without departing from the scope of the present disclosure. Accordingly, the detector 120 obtains data from emails sent and received at the email client 132 used by the user, attendees included in meetings scheduled on the calendar client 133, chats performed on the chat client 134, video conferences performed on the video conferencing client 135, and so forth to track interactions between the user and other individuals.

Based on the obtained data, the score generator 121 generates a familiarity score for each individual relative to the user. The familiarity score defines the strength of the relationship between the user and another individual based on one or more factors, including a number of interactions between the user and the individual, length of time of the interactions between the user and the individual, the type of interactions between the user and the individual, proximity between the user and the individual in an organization chart, amount of files shared between the user and the individual, and so forth. A higher familiarity score indicates a stronger relationship between the user and another individual, while a lower familiarity score indicates a weaker relationship between the user and another individual.

In some examples, the factors are weighted to emphasize different types of factors or interactions more heavily than others. For example, a familiarity score between a user and their direct supervisor or direct subordinate may be high due to the frequent interactions, but a familiarity score between a user and an individual in another department with which no interactions have occurred may be low. In another example, a familiarity score between the user and an individual who have had five emails exchanged back and forth may be lower than a familiarity score between the user and another individual who have had five video conference calls together due to the video conference calls having a higher weight in the familiarity score calculation than emails, due to the increased personal interaction in a video conference call relative to an email. In another examples, an organization chart is stored as one example of the data 116 and details different teams within the organization, historical data regarding project staffing, and so forth. Sharing a direct manager in the organization chart with the user is a factor that, in isolation, increases the familiarity score, while additional degrees of separation from the user in the organization chart is a factor that, in isolation, decreases the familiarity score.

The individual classifier 122 classifies each individual from the list of individuals as a stranger or not a stranger. In some examples, the individual classifier 122 compares each generated familiarity score with a familiarity score threshold to determine whether or not a particular individual is identified as a stranger. As referenced herein, a stranger is a person with which the user has had so few interactions with that the user is unlikely to be familiar with the other person, and as such may not know the other person's background and/or position in the organization.

The familiarity score threshold is a threshold familiarity score against which each generated familiarity score is compared to determine whether the generated familiarity score indicates the individual associated with the score is a stranger or not a stranger. In some examples, the familiarity score threshold is manually configured and/or adjusted by the user. For example, some users remember previous interactions more strongly and may desire to raise the familiarity score threshold for who is a stranger to them, while other users may recall previous interactions less strongly and may desire to lower the familiarity score threshold for who is a stranger to them. In other examples, the familiarity score threshold is dynamically and automatically updated by the individual classifier 122. For example, the individual classifier 122 implements a machine learning (ML) model to set the familiarity score threshold at a particular level where the individual is anticipated to derive a maximum benefit from the contextualization service 118. A generated familiarity score above the familiarity score familiarity score threshold indicates user is familiar enough with the individual associated with the generated familiarity score that the individual is not a stranger to the user, while a generated familiarity score below the familiarity score threshold indicates user is unfamiliar enough with the individual associated with the generated familiarity score that the individual is classified a stranger to the user.

In some examples, the individual classifier 122 filters out individuals from the list of strangers that are already known to the user or are expected to be known to the user. For example, where the user is friends with or connected to the stranger on the social media platform, where the individual is a direct manager of the user, where the individual is a direct report of the user, and so forth, the individual classifier 122 automatically classifies the individual as not a stranger, regardless of the generated familiarity score of the individual relative to the familiarity score threshold.

The contextualizer 124 obtains information associated with an individual who has been identified as a stranger by the individual classifier 122 and generates a stranger summary 126 of the stranger by filtering, or refining, the obtained information. The stranger summary 126 includes insights regarding a particular stranger. The insights provide context for the user prior to or immediately following an interaction between the user and the stranger. In some examples, the data obtained to generate the stranger summary 126 is pulled from various sources and filtered, or refined, to generate the insights compiled in the stranger summary 126. In some examples, the contextualizer 124 pulls the information from the organizational data. In some examples, the contextualizer 124 pulls the information from an external source, such as the cloud server 148. In some examples, the information pulled from the external source is one or more of a link to a social media platform of the stranger, enterprise products of the stranger, recent documents worked on or prepared by the stranger, a welcome message of the stranger on a chat application or social media platform, closest common connections with the stranger, a publicly available or internally available headshot of the stranger, and works with information regarding the stranger.

The contextualizer 124 generates the stranger summary 126 by filtering, or refining, the obtained information into an overview of the stranger to provide context for the user prior to or immediately following an interaction between the user and the stranger. In one example, the contextualizer 124 generates the stranger summary 126 using a headline pulled from the social media platform and/or closest common connections to the stranger. In other examples, the information is refined to provide specific details regarding the work of the stranger. In yet another example, the contextualizer 124 generates the stranger summary 126 using recent documents worked on or prepared by the stranger. The generated stranger summary 126 is then stored, for example as data in the data storage device 114. In some examples, the generated stranger summary 126 is stored in the data storage device 114 in the raw data format in which it is generated.

The contextualization service 118 provides an option to opt in or opt out of the service on an individual basis. In addition, the contextualization service 118 provides for various levels of opt-in or op-out, tailored to specific client applications. For example, the user may fully opt-in to the contextualization service 118 for each available client, where each application client used by the user is accessible to the detector 120 to contextualize possible strangers. In another example, the user fully opts out of the contextualization service 118, where data is not obtained from any of the application clients used by the user to contextualize possible strangers. In another example, the user opts-in to the contextualization service 118 for some application clients used by the user, but not all application clients. In this example, the user may opt-in to the contextualization service 118 for an email application client and a calendar application client, but opts out of the contextualization service 118 for a chat application client.

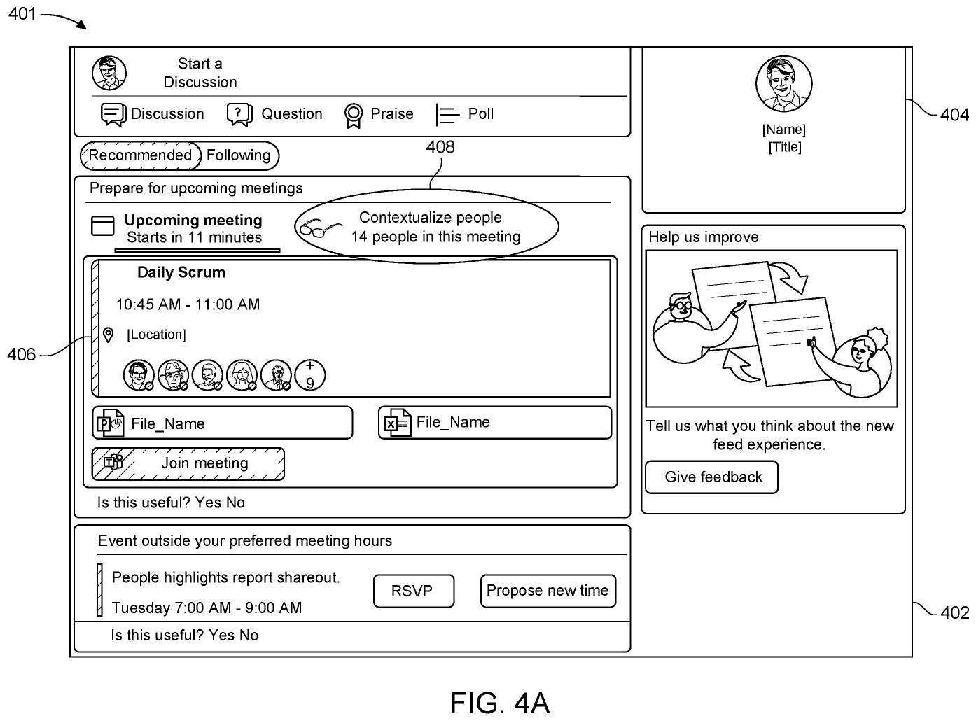

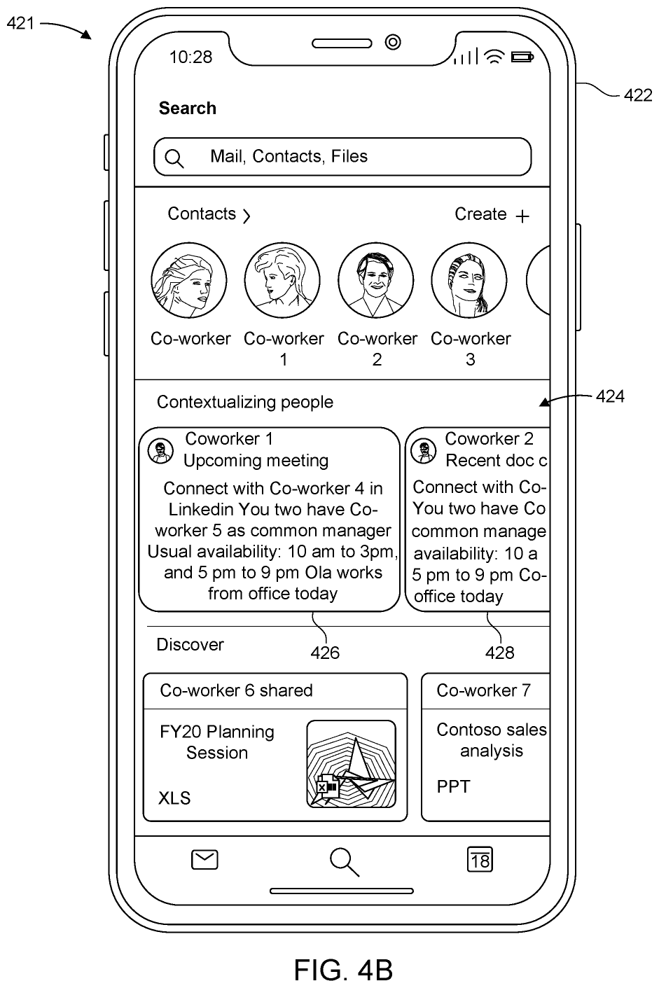

The platform 128 is implemented on the processor 108 and determines when to present the stranger summary 126 to the user and, at that time, converts the raw data of the generated stranger summary 126 into a format that can be consumed by a particular targeted enterprise application 130, as illustrated by the summary information shown in FIGS. 4A and 4B and described in greater detail below. For example, one or more of the feed 131, the email client 132, the calendar client 133, the chat client 134, and the video conferencing client 135 present content in different data formats. The platform 128 identifies a data format of a particular client, converts the raw data of the stranger summary 126 into the appropriate data format for the particular client, and presents the stranger summary 126 in the client-specific data format to the respective enterprise application 130 in anticipation of an interaction between the user and the stranger or in response to an interaction between the user and the stranger.

In some examples, the platform 128 presents the stranger summary 126 on one of the enterprise applications 130 proactively. As referenced herein, proactive refers to the platform 128 presenting information to one of the enterprise applications 130 before the user has requested such information in order to streamline the information presented to the user. For example, the platform 128 obtains data from the enterprise applications 130 to generate a list of individuals with whom the user has had interactions since the last interval of obtaining data, identifies which of the individuals are classified as strangers, and converts the raw data of the generated stranger summary 126 into a format that can be consumed by the particular targeted enterprise application 130.

For example, the stranger summary 126 is presented in the feed 131 to contextualize an identified stranger in an upcoming meeting in which the user is likely to interact with the stranger. This presentation is proactive because the stranger summary 126 is presented without the user directly requesting information related to the stranger and is presented before the meeting in which the user is likely to interact with the identified stranger.

In another example, the platform 128 presents the stranger summary 126 on one of the enterprise applications 130 reactively. As referenced herein, reactive refers to the platform 128 presenting information to one of the enterprise application 130 after an interaction between the user and a stranger has occurred. In some examples, the stranger summary 126 is presented to the user after an interaction between the user and the stranger has occurred, such as the user receiving an email from the stranger via the email client 132 or after a meeting in which the user and the stranger were each attendees. The reactive contextualization is provided as a reminder to the user regarding details about the stranger, details about the interaction with the stranger, an agenda to follow up with the stranger following the interaction, and so forth. In other words, the reactive presentation of an item is presented to the user in the feed after the interaction of the user with the stranger.

As described herein, the feed 131 is an interactive enterprise feed that presents, to a user, one or more of upcoming events, upcoming meetings, recent messages, documents or folders that have recently been shared with the user, and so forth. As referenced herein, interactive refers to the ability of the user to interact with data presented in the feed 131. For example, an item, such as a contextualization of a stranger, in the feed may be selected to view additional information regarding the item, an item in the feed may be minimized to reduce the information presented in the item, an item may be shared by the user, and so forth. In other words, the proactive presentation of an item is presented to the user in the feed prior to the interaction of the user with the stranger. Examples of the feed 131 are illustrated in FIGS. 4A and 4B and described in greater detail below.

The computing device 102 includes a relationship tracking service 136 that is implemented on the processor 108. The relationship tracking service 136 tracks the intensity of a particular relationship between the user and another individual and, based on a decreasing trend in the intensity, suggests reestablishment of the relationship. The relationship tracking service 136 includes a relationship tracker 138, a relationship ranker 140, and an insight generator 142.

The relationship tracker 138 tracks and scores relationships between the user and other individuals based on the intensity, or strength, of measurable interactions between the user and other individuals. The interactions are measured from one or more of the enterprise applications 130, such as emails sent to and from the user to different individuals using the email client 132, chats sent to and from the user to different individuals using the chat client 134, video conferences that are attended by the user and different individuals using the video conferencing client 135, and so forth. Information regarding meetings and video conferences further include the length of time and number of participants in the meeting or video conference. For example, meetings that are longer and/or include a fewer number of participants are considered to increase the intensity of the relationship between the user and another individual more so than a meeting that is shorter and/or has a greater number of participants, due to the expected greater amount of interaction between the user and another individual during the meeting longer meeting. In some examples, the relationship tracker 138 incorporates data obtained by the detector 120 to track the interactions between the user and other individuals.

The information regarding the number of emails sent and received, chats sent and received, meetings attended, and video conferences attended are aggregated. In various examples, the information is aggregated per day, per every three days, per every week, per every work week, or per month. The collaboration intensity, or strength, between the user and each other individual in which at least one interaction is measured is calculated by a linear combination of the values of the information regarding the number of emails sent and received, chats sent and received, and meetings. Coefficients of the linear combination are set heuristically. Accordingly, the relationship tracker 138 generates a single value that measures the collaboration intensity between the user and another individual. The relationship tracker 138 generates a separate collaboration intensity value for each other individual that has interacted with the user for a period of time, such as a week, two weeks, or a month. In some examples, each collaboration intensity value is marked with a time period for which the collaboration intensity value was calculated and stored as data in the data storage device 114.

In some examples, the relationship tracker 138 tracks and scores the relationships between the user and other individuals based on the familiarity score generated by the score generator 121. For example, the familiarity score can indicate the collaboration intensity between the user and the individual. A collaboration intensity greater than zero, or greater than another minimal value, indicates that the user and other individual are not strangers, and therefore the collaboration intensity of the relationship is tracked by the relationship tracker 138. _{[SG1]}

The relationship ranker 140 measures and tracks trends in the collaboration intensity values generated by the relationship tracker 138 over time. As the relationship tracker 138 generates a new collaboration intensity value for a given relationship between the user and another individual, the relationship ranker 140 compares the new collaboration intensity value to the previous collaboration intensity value between the user and the individual. Over a period of time that includes multiple collaboration intensity values, the relationship ranker 140 measures trends of collaboration intensity values, including whether the collaboration intensity values are increasing, decreasing, or staying the same.

In some examples, the relationship ranker 140 builds a list of candidate reconnection opportunities for the user by compiling, or generating, a listing of individuals with whom the user has a non-zero collaboration intensity value over a previous period of time. The period of time may be three weeks, four weeks, six weeks, ten weeks, twelve weeks, or any other suitable period of time to establish a trend in collaboration intensity values. The relationship ranker 140 removes a subset of other individuals from consideration of reconnection opportunities, such as if the user is a peer or manager of the other individual, if the user has had a recent one on one meeting with the other individual, if the other individual has been on leave during the period of time, if the other individual is determined to not be a real person, such as a bot, or if a relationship drop rate, or relationship drop slope, with the other individual is above a collaboration intensity threshold. By removing these individuals, the list of candidate reconnection opportunities excludes individuals who the user has recently connected with or individuals for whom there is a stronger likelihood that the decrease in interaction with the user has an alternative explanation that a decrease in intensity of the relationship.

As described herein, a relationship drop rate is calculated by the relationship ranker 140 as a function of weekly collaboration strength between the user and another individual with a large window size relative to weekly collaboration strength between the user and another individual with a relatively smaller window size. The slow-moving average is an average of collaboration intensity values over a relatively large number of values, such as eight, while the fast-moving average is an average of collaboration intensity values over a number of values that is smaller than the large window size, such as two. The relationship drop rate is then calculated as the slow-moving average divided by the fast-moving average, as defined by Equation 1.

$$Relationship Drop Rate = \frac{slow moving average}{fast moving average} \qquad Equation 1$$

As the relationship drop rate increases, the rate at which the interactions, i.e., collaboration intensity, between the user and the other individual are decreasing are increases. The relationship ranker 140 generates a ranked list of remaining people by the highest relationship drop rates as potential reconnections.

The insight generator 142 provides insights, or feedback, to the user regarding identified potential reconnections. For example, the insight generator 142 presents a subset of the ranked list to the user for potential reconnection. The subset of the ranked list may be a quantity of people, such as the individuals with the three, five, or ten highest relationship drop rates, or a percentage of people, such as the individuals within the top three, five, or ten percent of the relationship drop rates. In some examples, the feedback is presented on one or more of the enterprise applications 130. In some examples, the insights include actionable content for the user, such as direct Reconnect links to reconnect with the other individual through an email application, calendar application, or chat application. In some examples, the insights include a summary of the interactions between the user and the other individuals, such as a note indicating “you have not been in touch with John for some time now, do you want to reconnect?”

FIG. 1B is a system diagram illustrating a system for inferring and contextualizing a stranger on an enterprise platform according to examples of the present disclosure. The system 160 illustrated in FIG. 1B is provided for illustration only. Other examples of the system 160 can be used without departing from the scope of the present disclosure. FIG. 1B illustrates the interrelationships between the data storage device 114, the elements of the contextualization service 118, the platform 128, the elements of the enterprise applications 130, and the elements of the relationship tracking service 136.

In one example, the detector 120 obtains data from each of the feed 131, the email client 132, the calendar client 133, the chat client 134, and the video conferencing client 135. The score generator 121 uses the obtained data to generate a familiarity score for each individual relative to the user that defines the strength of the relationship between the user and another individual based on one or more factors, including a number of interactions between the user and the individual, length of time of the interactions between the user and the individual, the type of interactions between the user and the individual, proximity between the user and the individual in an organization chart, amount of files shared between the user and the individual, and so forth. The individual classifier 122 classifies each individual from the list of individuals as a stranger or not a stranger by comparing each familiarity score with a familiarity score threshold and filtering out individuals from the list of strangers that are already known to the user or are expected to be known to the user. The contextualizer 124 obtains information associated with an individual who has been identified as a stranger by the individual classifier 122 and generates a stranger summary 126 of the stranger by filtering, or refining, the obtained information.

The stranger summary 126 is stored in the data storage device 114. The platform 128 obtains data regarding interactions between the user and other individuals and, upon detection of an interaction with a stranger, converts the stored stranger summary 126 to an application-specific version of the stranger summary 126 and presents the application-specific version of the stranger summary 126 via one or more of the enterprise applications 130.

In another example, the relationship tracker 138 tracks and scores relationships between the user and other individuals based on the intensity, or strength, of measurable interactions between the user and other individuals. The interactions are measured from one or more of the enterprise applications 130, such as emails sent to and from the user to different individuals using the email client 132, chats sent to and from the user to different individuals using the chat client 134, video conferences that are attended by the user and different individuals using the video conferencing client 135, and so forth. The relationship ranker 140 measures and tracks trends in the collaboration intensity values generated by the relationship tracker 138 over time. The insight generator 142 provides insights, or feedback, to the user regarding identified potential reconnections based on a trend of decreasing collaboration intensity values between the user and another individual. In some examples, the insights include actionable content for the user, such as direct Reconnect links to reconnect with the other individual through an email application, calendar application, or chat application. In some examples, the insights include a summary of the interactions between the user and the other individuals with a recommendation to reestablish the relationship.

In some examples, the insights generated by the insight generator 142 are stored in the data storage device 114. In some examples, the platform 128 presents the summary generated by the insight generator 142 to the user on one or more of the enterprise applications 130.

FIG. 2 is a computerized method of inferring and contextualizing a stranger on an enterprise platform according to examples of the present disclosure. The computerized method of FIG. 2 is for illustration only and should not be construed as limiting. Various examples of the computerized method can be used without departing from the scope of the present disclosure. In some examples, the method 200 is implemented by the data storage device 114, the contextualization service 118, the platform 128, and/or one of the enterprise applications 130.

The method 200 begins by the detector 120 obtaining data from one or more enterprise applications 130, including but not limited to the feed 131, the email client 132, the calendar client 133, the chat client 134, and the video conferencing client 135, related to interactions between a user and other individuals in operation 202. As described herein, the data is obtained from at a regular interval, such as every hour, every two hours, every twelve hours, or every day, or obtained continuously in real-time. In another example, operation 202 is triggered based on the detector 120 determining, or receiving a notification, that a new individual has been added to the organization.

In operation 204, the score generator 121 generates a familiarity score for the user with each individual in an organization. The familiarity score defines the strength of the relationship between the user and another individual based on one or more factors, including a number of interactions between the user and the individual, a length of time of each interaction between the user and the individual, an elapsed time since the initial interaction between the user and the individual, the type of interactions between the user and the individual, proximity between the user and the individual in an organization chart, amount of files shared between the user and the individual, and so forth. A higher familiarity score indicates a stronger relationship between the user and another individual, while a lower familiarity score indicates a weaker relationship between the user and another individual.

In operation 206, the individual classifier 122 compares each generated familiarity score with the familiarity score threshold to classify the particular individual as a stranger or not. As described herein, higher familiarity scores indicate greater familiarity between the user and the particular individual, which in turn indicates the particular individual is less likely to be a stranger, whereas lower familiarity scores indicate less familiarity between the user and the particular individual, which in turn indicates the particular individual is more likely to be a stranger. Accordingly, where the familiarity score is above the threshold, in operation 208 the individual classifier 122 classifies the particular individual as not a stranger and stores the classification as data in the stored data 116. In operation 210, the individual classifier 122 determines whether a classification of another individual is needed. If so, the method 200 returns to operation 204. If not, the method 200 terminates.

Where, in operation 206, the familiarity score is below the threshold, in operation 212 the individual classifier 122 classifies, or flags or identifies, the particular individual as a stranger. In some examples, the status of the particular individual as a stranger is stored in the data storage device 114.

In operation 214, the contextualizer 124 determines whether the identified stranger is internal to the organization of the user or external to the organization of the user. In operation 216, the contextualizer 124 obtains information regarding the particular individual who has been identified as a stranger in operation 212. In some examples, the information is retrieved from various sources. In examples where the stranger is determined to be internal of the organization of the user in operation 214, the contextualizer 124 pulls the information from stored organizational data and/or from an external source, such as the cloud server 148. In examples where the stranger is determined to be external of the organization of the user in operation 214, only information from an external source is available to be used for contextualization. In some examples, the information pulled from the external source is one or more of a link to a social media platform of the stranger, enterprise products of the stranger, recent documents worked on or prepared by the stranger, a welcome message of the stranger on a chat application or social media platform, closest common connections with the stranger, a publicly available or internally available headshot of the stranger, and works with information regarding the stranger.

In operation 218, the contextualizer 124 generates a stranger summary 126 based on the information pulled in operation 216. The stranger summary 126 includes insights regarding a particular stranger. The insights provide context for the user prior to or immediately following an interaction between the user and the stranger. The data obtained to generate the stranger summary 126 is pulled from various sources and filtered, or refined, to generate the insights compiled in the stranger summary 126._{[SG2]} In some examples, the contextualizer 124 generates the stranger summary 126 using a headline pulled from the social media platform and/or closest common connections to the stranger. In other examples, the information is refined to provide specific details regarding the work of the stranger. In this example, the contextualizer 124 generates the stranger summary 126 using recent documents worked on or prepared by the stranger and works with information regarding the stranger.

The method 200 then returns to operation 210, where the individual classifier 122 determines whether a classification of another individual is needed. If classification of another individual is needed, the method 200 returns to operation 204. If classification of another individual is not needed, the method 200 terminates.

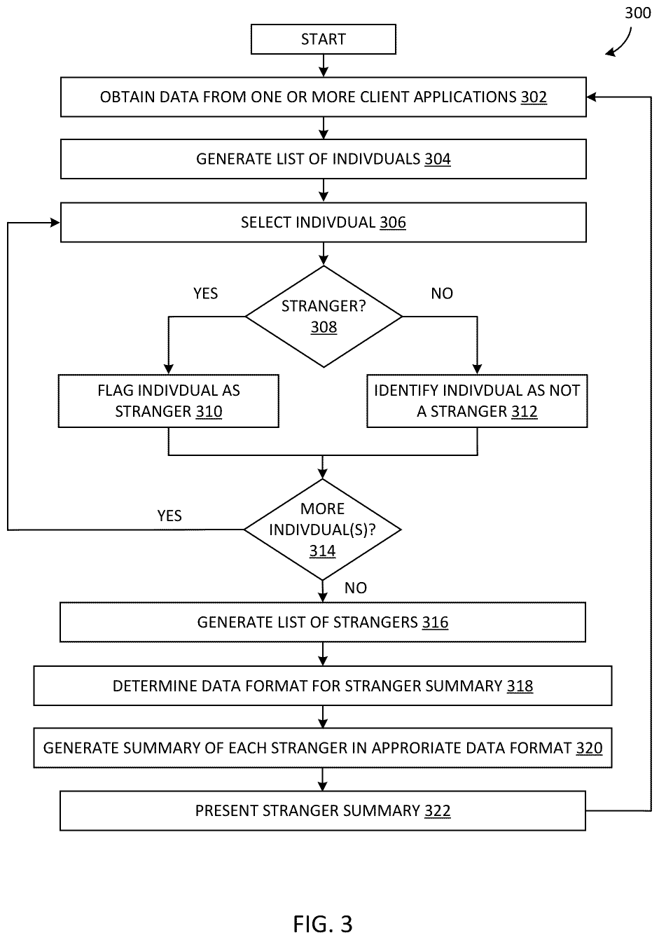

FIG. 3 is a computerized method of generating a feed including one or more contextualized strangers according to examples of the present disclosure. The computerized method of FIG. 3 is for illustration only and should not be construed as limiting. Various examples of the computerized method can be used without departing from the scope of the present disclosure. In some examples, the method 300 is implemented by the platform 128 and/or one of the enterprise applications 130.

The method 300 begins by the platform 128 obtaining data from one or more enterprise applications 130 in operation 302. In some examples, the platform 128 obtains data from the enterprise applications 130 including the feed 131, the email client 132, the calendar client 133, the chat client 134, and the video conferencing client 135 at a regular interval of time, as described herein. In some examples, the platform 128 obtains data from the enterprise applications 130 including the feed 131, the email client 132, the calendar client 133, the chat client 134, and the video conferencing client 135 in real time in order to present the stranger summary 126 in real time.

In some examples, data is only obtained from meetings, emails, and chat groups of a certain size in order to keep a list of potential strangers to be contextualized manageable for the user. For example, the platform 128 may set a size threshold for meetings to obtain data from, such as five people, ten people, and so forth. The inclusion of a size threshold for meetings, emails, chats, and video conferences excludes situations where an organization-wide email or meeting is scheduled, which could result in an overwhelming quantity of strangers ultimately being presented to the user and key strangers for upcoming, smaller meetings being overlooked by the user.

In operation 304, the platform 128 generates a list of individuals identified based on the obtained data. The list of individuals is compiled based on all individuals identified in interactions with the user since the last interval of obtaining data, including upcoming calendar events on the calendar client 133, all individuals identified in emails sent or received on the email client 132, all individuals identified in chats with the user on the chat client 134, all individuals scheduled to attend video conference invitations sent or received on the video conferencing client 135, and so forth. In some examples, the list of individuals is generated for a particular time period in advance of the current date and time. For example, the platform 128 generates the list of individuals for a range of one day ahead and behind, two days ahead and behind, three days ahead and behind, one week ahead and behind, and so forth.

In operation 306, the platform 128 selects a particular individual from the generated list and in operation 308, determines whether the individual is a stranger. For example, the platform 128 identifies the individual, such as by a name, employee identification (ID) number, and so forth, and searches for the individual in data stored in the data storage device 114. In some examples, the data stored for each individual includes an indication of for which other individuals the particular individual is a stranger and for which other individuals the particular individual is not a stranger, as identified using the method 200 described herein. Where the individual is identified as a stranger to the user, the platform 128 flags the individual as a stranger in operation 310 and where the individual is identified as not a stranger to the user, the platform 128 identifies the individual as not a stranger in operation 312.

In operation 314, the platform 128 determines whether another individual is to be identified as a stranger or not a stranger from the generated list of individuals. Where one or more individuals are to be identified, the method 300 returns to operation 306 and the platform 128 selects the next individual for identification as a stranger or not a stranger. Where, in operation 314, the platform 128 determines no more individuals, the method 300 proceeds to operation 316 and the platform 128 generates a list of the strangers. The list of strangers includes each individual flagged as a stranger.

In operation 318, the platform 128 determines a data format in which the stranger summary 126 is to be presented. As described herein, each enterprise application 130 presents data in a different data format. The platform 128 determines upon which enterprise application 130 is the stranger summary 126 to be presented. For example, where the platform 128 determines the stranger summary 126 is presented on a mobile version of the feed 131, the platform determines the data format for the mobile version of the feed 131. In another example, where the platform 128 determines the stranger summary 126 is to be presented on the email client 132, the platform 128 determines the data format for the email client 132.

In operation 320, the platform 128 generates an application-specific version of the stranger summary 126 for each stranger in the list of strangers. The application-specific version of the stranger summary 126 is generated in the data format determined in operation 318. For example, where the stranger summary 126 is presented on the mobile version of the feed 131, the platform generates the application-specific version of the stranger summary 126 for the mobile version of the feed 131. The stranger summary 126 includes information regarding the stranger to contextualize them for the user as generated by the contextualizer 124. For example, the summary may include a name of the stranger, position of the stranger, recent projects the stranger has worked on, and so forth.

In operation 322, the application-specific version of the stranger summary 126 is presented in the appropriate format on the respective enterprise application 130. For example, the stranger summary 126 may be presented on the feed 131, as illustrated in FIGS. 4A and 4B and described in greater detail below, on the email client 132, on the calendar client 133, on the chat client 134, or on the video conferencing client 135. The stranger summary 126 may be presented on any type of external device 150, such as a mobile electronic device, a wearable electronic device, a tablet, a laptop computer, a desktop computer, a virtual reality (VR) device, an augmented reality (AR) device, or any other suitable electronic device.

In some examples, the method 300 operates continuously. In other words, once the summary is presented on the external device 150, the method 300 returns to operation 302 and continues to obtain data from the enterprise applications 130. In other examples, the method 300 is terminated following the summary being presented on the external device. For example, where the user opts out of a service that executes the method 300, the method 300 terminates.

It should be understood that each of the methods 200 and 300, presented in FIGS. 2 and 3, respectively, are performed for each person in the organization. The methods 200, 300 are performed for a first user, a second user, and so forth, such that a familiarity score is generated for each user with each other member of the organization and, based on interactions detected by obtaining data from the enterprise applications 130, a summary including one or more contextualized strangers may be presented to multiple users concurrently.

FIG. 4A is an example of a generated feed including one or more contextualized strangers according to examples of the present disclosure. The example of the feed 401 is presented for illustration only. Various examples of the feed 401 may be presented without departing from the scope of the present disclosure. In some examples, the feed 401 is an example of the feed 131.

The feed 401 is presented on a user interface 402, such as the user interface of the external device 150. In various examples, the feed 401 is presented in a browser or as a standalone application. The feed 401 includes user information 404. The user information 404 presents an overview of the user logged in to the feed 401, such as the user's name, position, number of followers, and so forth.

The feed 401 further includes a card 406 that presents information related to an upcoming meeting. However, various examples are possible. The card 406, or item, may present information related to new chat messages, tasks to be completed, recently completed tasks, organization information, announcements, and so forth without departing from the scope of the present disclosure.

The feed 401 further includes a tab 408. In some examples, the tab 408 presents the stranger summary 126 generated in operation 322. The tab 408 corresponds to the card 406 and, when selected, presents the stranger summary 126 in the application-specific data format to provide contextualized information regarding strangers in the meeting that is presented in the card 406. For example, the card 406 presents an upcoming meeting and the tab 408, when selected, presents a generated list of contextualized strangers that are expected to be present in the upcoming meeting presented in the card 406. In some examples, the tab 408, when selected, presents a generated list of all contextualized strangers who were invited to the meeting presented in the card 406. In some examples, the tab 408, when selected, presents a generated list of all contextualized strangers who were invited and have accepted, or provided an RSVP indicating their anticipated presence at, the meeting presented in the card 406.

Other examples of the card 406 and tab 408 may be presented according to various examples of the present disclosure. In one example, the card 406 may present a new email in the email client 132 and the tab 408 indicates an option to present a list of contextualized strangers included on the email thread. In another example, the card 406 may present a new chat message in the chat client 134 and the tab 408 indicates an option to present a list of contextualized strangers to whom the chat message was sent. In some examples, only meetings, emails, chats, and so forth where there are strangers to contextualize include the tab 408. Further, as described herein, individuals who have not been identified as strangers do not appear in the contextualize tab, rather than all attendees of the meetings, individuals included on the email thread, and so forth in order to avoid burdening the user by repeatedly providing information about individuals they are already familiar with. Accordingly, the feed 401 assists the user to target a discussion with the stranger, reduces the risk of discussing irrelevant topics, and saves the user time as the information provided reduces the need for manual search for public information about each stranger.

FIG. 4B is an example of a generated feed including one or more contextualized strangers according to examples of the present disclosure. The example of the feed 421 is presented for illustration only. Various examples of the feed 421 may be presented without departing from the scope of the present disclosure. In some examples, the feed 421 is an example of the feed 131.

The feed 421 is presented on a user interface 422. In some examples, the example of the feed 421 is presented on a mobile user interface 422, such as on a mobile electronic device or a tablet. Like the feed 401, the feed 421 includes a tab 424 that presents the stranger summary 126 generated in operation 322. For example, the tab 424 presents a first contextualized stranger 426 and a second contextualized stranger 428. For example, each of the contextualized strangers 426, 428 present a publicly available or internally available headshot of the stranger, a name of the stranger, a summary of the stranger, and an indication of where the user will encounter the stranger or has recently encounter the stranger. In some examples, the contextualized stranger 426, 428 includes an option to connect with the stranger on a social platform.

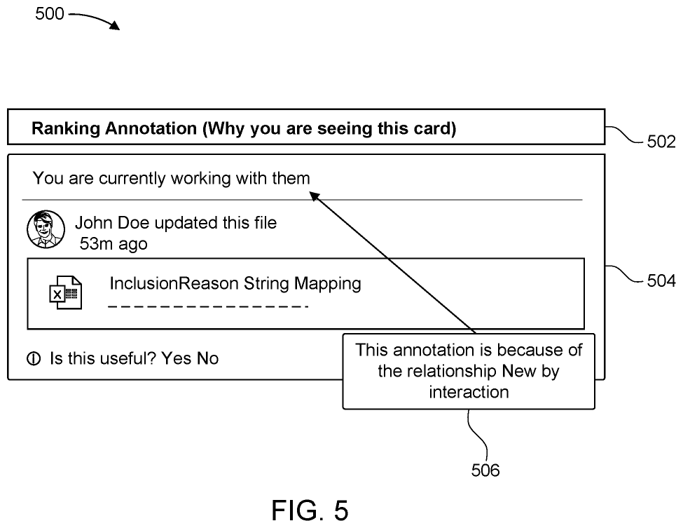

In other examples, a tab, such as the tab 424, that annotates received content from a stranger is presented to the user on the external device 150. For example, FIG. 5 is an example of a ranking annotation 500 that presents a tab 502 to contextualize a stranger from whom content is received. The ranking annotation 500 further includes contextualization data 504 regarding the stranger. The contextualization data 504 includes identification of a stranger, an interaction with the stranger, and a description 506 of why the stranger the has been identified as a stranger and contextualized. In the example illustrated in FIG. 5, the contextualization data 504 includes the name and headshot of the stranger, an interaction with the stranger, i.e., that the stranger has updated a file, and a description 506 identifying that the relationship is new by interaction and the user is currently working with the stranger. In some examples, the ranking annotation 500 is generated by the platform 128. The ranking annotation 500 may be presented on one of the enterprise applications 130.

Although FIGS. 4A and 4B illustrate examples of the stranger summary 126 presented in the feed 131, it should be understood that the stranger summary 126 may be presented to the user in various different formats or on various enterprise applications 130. In some examples, the stranger summary 126 is presented to the user on the video conferencing client 135 while a stranger attends the same meeting as the user. In some examples, the stranger summary 126 is presented to the user on the calendar client 133 while the user views details regarding a given meeting at which a stranger is an expected attendee. In some examples, the stranger summary 126 is presented to the user on the email client 132, such as when the user receives an email from a stranger or when a received email includes other recipients that are strangers. In some examples, the stranger summary 126 is presented to the user on that chat client 134, such as when the user receives a chat message or request form the stranger.

In some examples, the stranger summary 126 is presented to the user in an internal enterprise search. For example, within a company internal enterprise search, the relevance of a search result often depends on who has written the document, such as where in the organization is the author and what the authors area of expertise is. The contextualization service may be implemented by a search result page (SERP) to provide the end user more information about the author or set of authors of each result.

In one particular example, a user is anticipated to attend a meeting with a select group of people from their organization that includes multiple teams from across the organization. The purpose of the meeting is to make decisions about a project. While each team has a voice in the function they are contributing to the project, the final decision requires coordination across all of the teams. The user identifies, or notices, a stranger in the meeting invite and is not sure which part of the project is of interest to the stranger. The stranger summary 126 is presented to contextualize strangers in the upcoming meeting. This enables the user to identify strangers anticipated to attend the meeting without conducting an external search, which is less comprehensive and requires considerable, additional time to perform. In this particular example, the information presented in the contextualized summary of the stranger includes one or more of contextualized information from an enterprise social platform, contextualized information obtained by email mining and other available information, messages welcoming the contextualized stranger to the organization or to the user, messages welcoming the contextualized stranger to a particular team in the organization, information related to the closest common manager between the user and the contextualized stranger, and common connections between the user and the contextualized stranger.

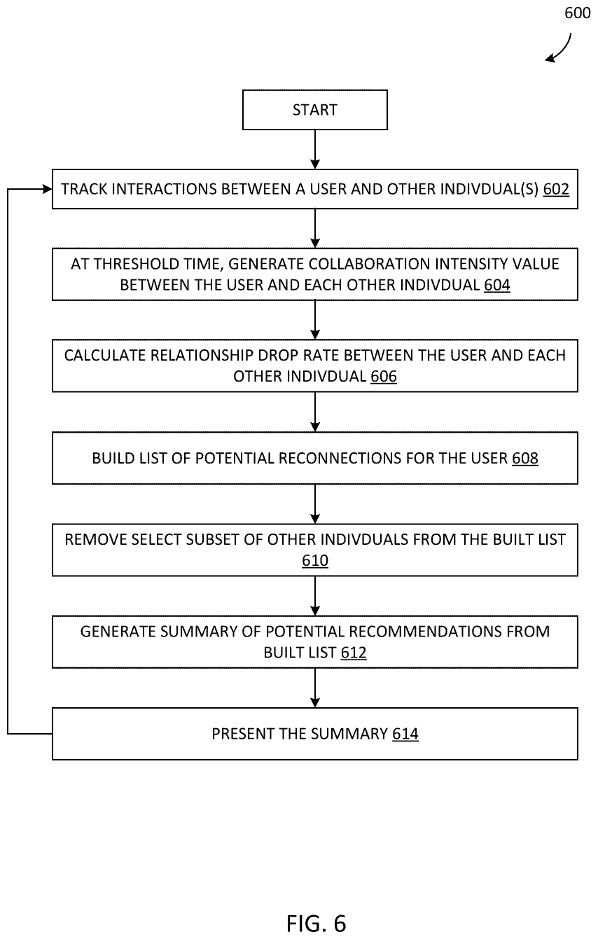

FIG. 6 is a computerized method of inferring and facilitating reestablishment of a relationship according to examples of the present disclosure. The computerized method of FIG. 6 is for illustration only and should not be construed as limiting. Various examples of the computerized method can be used without departing from the scope of the present disclosure. In some examples, the method 600 is implemented by the data storage device 114, the platform 128, the enterprise application 130, and/or the relationship tracking service 136.

The method 600 begins by the relationship tracker 138 tracking interactions between a user and each other individual with whom the user interacts in operation 602. For example, the relationship tracker 138 tracks and stores the number of emails and chats sent to and from the user to different individuals and meetings that are attended by the user and different individuals by obtaining data from the enterprise applications 130. By obtaining data from the enterprise applications 130, the relationship tracker 138 tracks emails sent to and received by the user to other individuals, other individuals copied on emails sent to and received by the user, calendar events attended by the user and other individuals, chats the user sends to and receives from other individuals, and so forth.

In operation 604, at a threshold time, the relationship tracker 138 generates a collaboration intensity value between the user and each other individual with whom the user has interacted within the previous time period. For example, the collaboration intensity value may be calculated at a threshold time of every day, every three days, every week, every work week, or every month. As described herein, the collaboration intensity, or strength, between the user and each other individual in which at least one interaction is measured is calculated by a linear combination of the values of the information regarding the number of emails sent and received, chats sent and received, and meetings. Coefficients of the linear combination are set heuristically. In some examples, each collaboration intensity value is stored in the data storage device 114 as data and marked with a time period for which the collaboration intensity value was calculated. In some examples, the relationship tracker 138 defines the collaboration intensity value based on the familiarity score generated by the score generator 121. For example, the familiarity score generated by the score generator 121 is a measure of the collaboration intensity between the user and another individual, and the collaboration intensity value is generated by the relationship tracker 138 to define the collaboration intensity measured by the generated familiarity score.

In operation 606, the relationship ranker 140 calculates a relationship drop rate between the user and each other individual for whom a collaboration intensity value is stored. The relationship ranker 140 measures and tracks trends in the collaboration intensity values generated by the relationship tracker 138 over time. A relationship drop rate is calculated by the relationship ranker 140 as a function of weekly collaboration strength between the user and another individual with a large window size relative to weekly collaboration strength between the user and another individual with a relatively smaller window size. The slow-moving average is an average of collaboration intensity values over a relatively large number of values, such as eight, while the fast-moving average is an average of collaboration intensity values over a number of values that is smaller than the large window size, such as two. The relationship drop rate is then calculated as the slow-moving average divided by the fast-moving average, as defined by Equation 1.

In operation 608, the relationship ranker 140 builds a list of potential reconnections for the user. In some examples, for a user, the relationship ranker 140 ranks each other individual based on the calculated relationship drop rate from the highest relationship drop rate to the lowest relationship drop rate. In operation 610, the relationship ranker 140 removes a select subset of individuals from the built list. The removed subset of individuals are individuals with whom the relationship ranker 140 determines a reconnection is not necessary for the user due to various possible circumstances, including if the user is a peer or manager of the other individual, if the user has had a recent one on one meeting with the other individual, if the other individual has been on leave during the period of time, if the other individual is determined to not be a real person, such as a bot, or if a relationship drop rate, or relationship drop slope, with the other individual is above a threshold.

In operation 612, the insight generator 142 generates a summary of potential recommendations for whom the user can reconnect from the built list as feedback to the user. The generated summary includes a subset of individuals for whom the user has the highest relationship drop rates. The subset of the ranked list may be a quantity of people, such as the individuals with the three, five, or ten highest relationship drop rates, or a percentage of people, such as the individuals within the top three, five, or ten percent of the relationship drop rates.

In operation 614, the platform 128 presents the summary generated by the insight generator 142 to the user. In some examples, the summary includes actionable content for the user, such as direct Reconnect links to reconnect with the other individual through an email application, calendar application, or chat application. In some examples, the generated summary is presented on one or more of the enterprise applications 130.

It should be understood that the method 600, presented in FIG. 6, is performed for each person in the organization. The method 600 is performed for a first user, a second user, and so forth, such that a collaboration intensity value is generated for each user with each other member of the organization and, based on the calculated drop rate, a summary including potential recommendations for reconnection may be presented to multiple users concurrently.

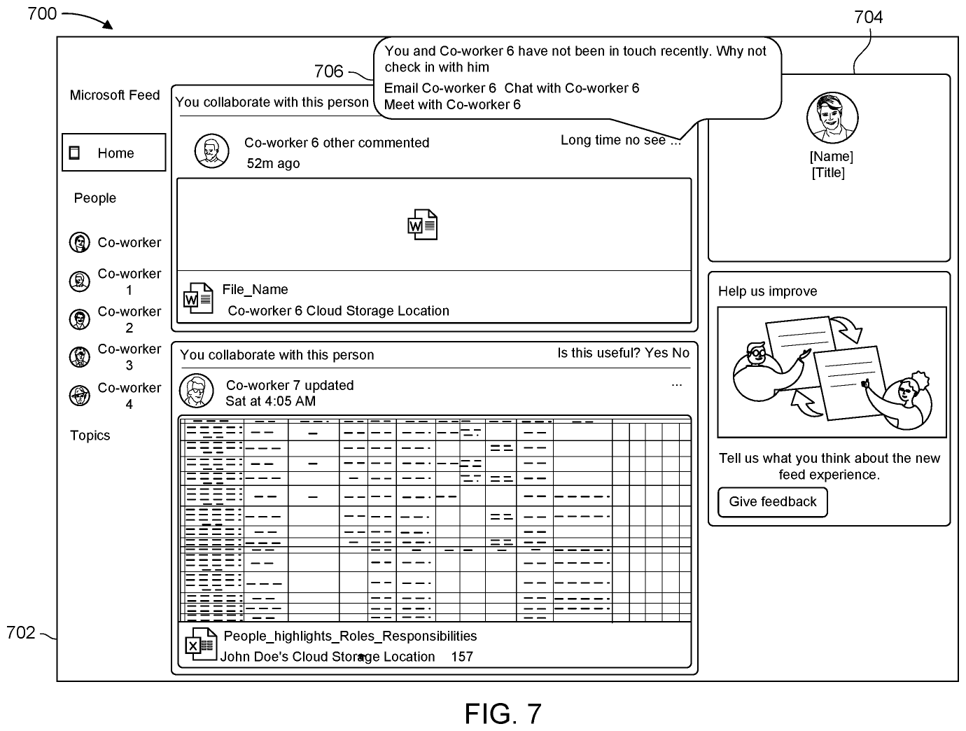

FIG. 7 is an example of a generated feed including one or more relationships for reestablishment according to examples of the present disclosure. The example of the feed 700 is presented for illustration only. Various examples of the feed 700 may be presented without departing from the scope of the present disclosure. In some examples, the feed 700 is an example of the feed 131.

The feed 700 is presented on a user interface 702, such as the user interface of the external device 150. In various examples, the feed 700 is presented in a browser or one or more of the enterprise applications 130. The feed 700 includes user information 704. The user information 704 presents an overview of the user logged in to the feed 700, such as the user's name, position, number of followers, and so forth.

The feed 700 further includes a summary 706. The summary 706 indicates on the feed 700 that the user has not interacted with a particular coworker, such as coworker F, recently. The summary 706 includes links to email coworker F, chat with coworker F, or to meet with coworker F. In some examples, each link corresponds to a separate client plug-in, such as an API, that interfaces with a respective enterprise application 130. For example, selecting the link to email coworker F opens the email client 132 with a window send an email to coworker F, selecting the link to chat with coworker F opens the chat client 134 with a window to send a chat to coworker F, and selecting the link to meet with coworker F activates the calendar client 133 with a window to send a new meeting invitation to coworker F.

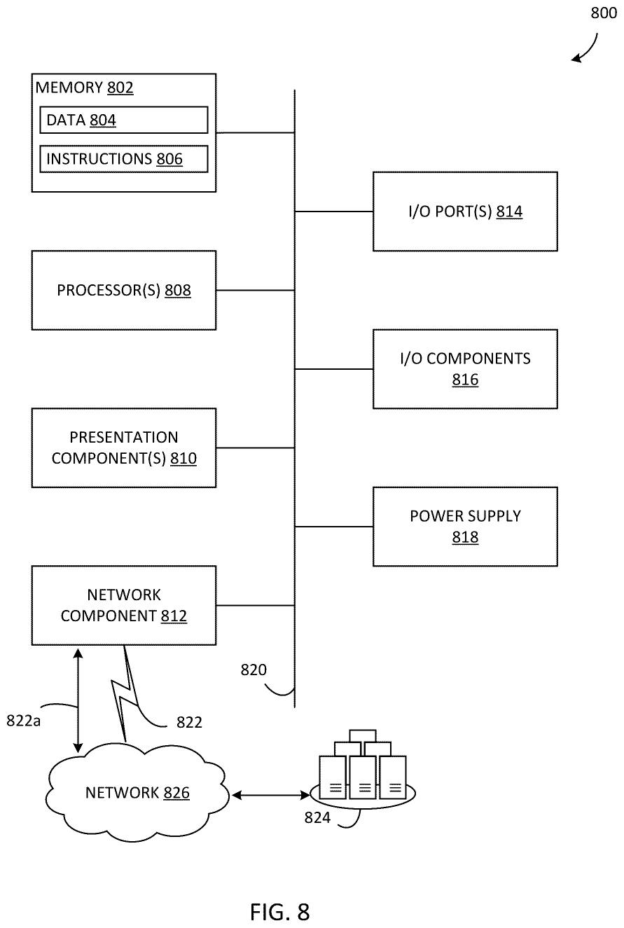

FIG. 8 is a block diagram of an example computing device 800 for implementing aspects disclosed herein and is designated generally as computing device 800. Computing device 800 is an example of a suitable computing environment and is not intended to suggest any limitation as to the scope of use or functionality of the examples disclosed herein. Neither should computing device 800 be interpreted as having any dependency or requirement relating to any one or combination of components/modules illustrated. The examples disclosed herein may be described in the general context of computer code or machine-useable instructions, including computer-executable instructions such as program components, being executed by a computer or other machine, such as a personal data assistant or other handheld device.

Generally, program components including routines, programs, objects, components, data structures, and the like, refer to code that performs particular tasks, or implement particular abstract data types. The disclosed examples may be practiced in a variety of system configurations, including personal computers, laptops, smart phones, mobile tablets, hand-held devices, consumer electronics, specialty computing devices, etc. The disclosed examples may also be practiced in distributed computing environments when tasks are performed by remote-processing devices that are linked through a communications network.

In some examples, the computing device 800 is the computing device 102. Accordingly, the memory 802, the processor 808, the presentation component(s) 810, and the network 826 can be the memory 104, the processor 108, the user interface 110, and the network 146, respectively. However, these examples should not be construed as limiting. Various examples are possible.

Computing device 800 includes a bus 820 that directly or indirectly couples the following devices: computer-storage memory 802, one or more processors 808, one or more presentation components 810, I/O ports 814, I/O components 816, a power supply 818, and a network component 812. While computing device 800 is depicted as a seemingly single device, multiple computing devices 800 may work together and share the depicted device resources. For example, memory 802 may be distributed across multiple devices, and processor(s) 808 may be housed with different devices.

Bus 820 represents what may be one or more busses (such as an address bus, data bus, or a combination thereof). Although the various blocks of FIG. 8 are shown with lines for the sake of clarity, delineating various components may be accomplished with alternative representations. For example, a presentation component such as a display device is an I/O component in some examples, and some examples of processors have their own memory. Distinction is not made between such categories as “workstation,” “server,” “laptop,” “hand-held device,” etc., as all are contemplated within the scope of FIG. 8 and the references herein to a “computing device.” Memory 802 may take the form of the computer-storage media references below and operatively provide storage of computer-readable instructions, data structures, program modules and other data for computing device 800. In some examples, memory 802 stores one or more of an operating system, a universal application platform, or other program modules and program data. Memory 802 is thus able to store and access data 804 and instructions 806 that are executable by processor 808 and configured to carry out the various operations disclosed herein.

In some examples, memory 802 includes computer-storage media in the form of volatile and/or nonvolatile memory, removable or non-removable memory, data disks in virtual environments, or a combination thereof. Memory 802 may include any quantity of memory associated with or accessible by computing device 800. Memory 802 may be internal to computing device 800 (as shown in FIG. 8), external to computing device 800, or both. Examples of memory 802 in include, without limitation, random access memory (RAM); read only memory (ROM); electronically erasable programmable read only memory (EEPROM); flash memory or other memory technologies; CD-ROM, digital versatile disks (DVDs) or other optical or holographic media; magnetic cassettes, magnetic tape, magnetic disk storage or other magnetic storage devices; memory wired into an analog computing device; or any other medium for encoding desired information and for access by computing device 800.

Additionally, or alternatively, memory 802 may be distributed across multiple computing devices 800, for example, in a virtualized environment in which instruction processing is carried out on multiple computing devices 800. For the purposes of this disclosure, “computer storage media,” “computer-storage memory,” “memory,” and “memory devices” are synonymous terms for computer-storage memory 802, and none of these terms include carrier waves or propagating signaling.

Processor(s) 808 may include any quantity of processing units that read data from various entities, such as memory 802 or I/O components 816 and may include CPUs and/or GPUs. Specifically, processor(s) 808 are programmed to execute computer-executable instructions for implementing aspects of the disclosure. The instructions may be performed by the processor, by multiple processors within computing device 800, or by a processor external to client computing device 800. In some examples, processor(s) 808 are programmed to execute instructions such as those illustrated in the in the accompanying drawings. Moreover, in some examples, processor(s) 808 represent an implementation of analog techniques to perform the operations described herein. For example, the operations may be performed by an analog client computing device 800 and/or a digital client computing device 800. Presentation component(s) 810 present data indications to a user or other device. Exemplary presentation components include a display device, speaker, printing component, vibrating component, etc. One skilled in the art will understand and appreciate that computer data may be presented in a number of ways, such as visually in a graphical user interface (GUI), audibly through speakers, wirelessly between computing devices 800, across a wired connection, or in other ways. I/O ports 814 allow computing device 800 to be logically coupled to other devices including I/O components 816, some of which may be built in. Example I/O components 816 include, for example but without limitation, a microphone, joystick, game pad, satellite dish, scanner, printer, wireless device, etc.

Computing device 800 may operate in a networked environment via network component 812 using logical connections to one or more remote computers. In some examples, network component 812 includes a network interface card and/or computer-executable instructions (e.g., a driver) for operating the network interface card. Communication between computing device 800 and other devices may occur using any protocol or mechanism over any wired or wireless connection. In some examples, network component 812 is operable to communicate data over public, private, or hybrid (public and private) using a transfer protocol, between devices wirelessly using short range communication technologies (e.g., near-field communication (NFC), Bluetooth™ branded communications, or the like), or a combination thereof. Network component 812 communicates over wireless communication link 822 and/or a wired communication link 822a to a cloud resource 824 across network 826. Various different examples of communication links 822 and 822a include a wireless connection, a wired connection, and/or a dedicated link, and in some examples, at least a portion is routed through the internet.

Although described in connection with an example computing device, examples of the disclosure are capable of implementation with numerous other general-purpose or special-purpose computing system environments, configurations, or devices. Examples of well-known computing systems, environments, and/or configurations that may be suitable for use with aspects of the disclosure include, but are not limited to, smart phones, mobile tablets, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, virtual reality (VR) devices, augmented reality (AR) devices, mixed reality (MR) devices, holographic device, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure may include different computer-executable instructions or components having more or less functionality than illustrated and described herein. In examples involving a general-purpose computer, aspects of the disclosure transform the general-purpose computer into a special-purpose computing device when configured to execute the instructions described herein.

By way of example and not limitation, computer readable media comprise computer storage media and communication media. Computer storage media include volatile and nonvolatile, removable, and non-removable memory implemented in any method or technology for storage of information such as computer readable instructions, data structures, program modules, or the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, solid-state memory, phase change random-access memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media typically embody computer readable instructions, data structures, program modules, or the like in a modulated data signal such as a carrier wave or other transport mechanism and include any information delivery media.

The order of execution or performance of the operations in examples of the disclosure illustrated and described herein is not essential and may be performed in different sequential manners in various examples. For example, it is contemplated that executing or performing a particular operation before, contemporaneously with, or after another operation is within the scope of aspects of the disclosure. When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense. Additional Examples

An example system includes a memory and a processor communicatively coupled to the memory. The system further includes a contextualization service, implemented on the processor, that generates a familiarity score between a user and an individual, determines the individual is a stranger to the user, generates a contextualized summary of the stranger, and sends, to a user interface (UI) for presentation, the generated contextualized summary of the stranger to the user in response to an upcoming interaction between the user and the stranger or a detected interaction between the user and the stranger.

An example computerized method includes generating a familiarity score between a user and an individual, determining that the individual is a stranger to the user based on the generated familiarity score, generating a contextualized summary of the stranger, and presenting the generated contextualized summary of the stranger to the user.

An example computer-readable storage media includes instructions that, when executed by a processor, cause the processor to monitor interactions between a user and an individual, generate a relationship drop rate between the user and the individual based on the monitored interactions, determine the relationship drop rate is below a collaboration intensity threshold, and control a user interface (UI) to present a reconnection notification to the user based on the relationship drop rate being below the collaboration intensity threshold, wherein the presented notification includes a link that, when selected, reconnect the user with the individual.

Alternatively, or in addition to the other examples described herein, examples include any combination of the following:
wherein the generated familiarity score is based on at least one of a number of interactions between the user and the individual, a length of time of the interactions between the user and the individual, an elapsed time since an initial interaction between the user and the individual, a type of the interactions between the user and the individual, a proximity between the user and the individual in an organization chart, and an amount of files shared between the user and the individual;
wherein determining the individual is the stranger to the user further comprises determining the generated familiarity score is below a familiarity score threshold;
wherein generating the contextualized summary of the stranger further comprises obtaining data associated with the stranger, filtering the obtained data to generate insights about the stranger, and generating a summary of the stranger, the summary including the generated insights;
determining the stranger is internal to an organization of the user, and generating the contextualized summary of the stranger based on information obtained from stored organizational data;
determining the stranger is internal to an organization of the user, and generating the contextualized summary of the stranger based on information obtained from an external source; generating a list of strangers to the user, determining an appropriate format for a summary of the stranger for a target display application, and generating the contextualized summary for each respective stranger in the determined appropriate format;
determining the appropriate format based on an application whereby the contextualized summary is presented;
detecting an upcoming interaction between the user and the stranger;
based on the detected upcoming interaction, presenting the generated contextualized summary of the stranger to the user;
detecting an interaction between the user and the stranger;
based on the detected interaction, presenting the generated contextualized summary of the stranger to the user;
wherein presenting the contextualized summary further comprises presenting the contextualized summary in an enterprise application;
identifying a decreasing trend in the generated familiarity score over time between the user and the individual;
presenting a reconnection notification to the user, wherein the presented summary includes a link that, when selected, reconnect the user with the individual;
generating a relationship drop rate between the user and the individual;
determining the relationship drop rate is below a collaboration intensity threshold;
based on the relationship drop rate being below the collaboration intensity threshold, determining the decreasing trend in the generated familiarity score;
determining that the individual is known to the user based on the generated familiarity score, and determining whether a next individual is another stranger to the user;
identify the decreasing trend in the generated familiarity score over time between the user and each of a plurality of individuals;
generate a list of potential reconnections for the user, the list including the plurality of individuals; and
remove a subset of individuals from the generated list, the removed subset of individuals including a peer or manager of the user.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

What is claimed is:

1. A computerized method, comprising:
generating a familiarity score between a user and an individual;
determining that the individual is a stranger to the user based on the generated familiarity score;
generating a contextualized summary of the stranger; and
presenting the generated contextualized summary of the stranger to the user.

2. The computerized method of claim 1, wherein the generated familiarity score is based on at least one of a number of interactions between the user and the individual, a length of time of the interactions between the user and the individual, an elapsed time since an initial interaction between the user and the individual, a type of the interactions between the user and the individual, a proximity between the user and the individual in an organization chart, and an amount of files shared between the user and the individual.

3. The computerized method of claim 1, wherein determining the individual is the stranger to the user further comprises:
determining the generated familiarity score is below a familiarity score threshold.

4. The computerized method of claim 1, wherein generating the contextualized summary of the stranger further comprises:
obtaining data associated with the stranger;
filtering the obtained data to generate insights about the stranger; and
generating a summary of the stranger, the summary including the generated insights.

5. The computerized method of claim 1, further comprising:
determining the stranger is internal to an organization of the user; and
generating the contextualized summary of the stranger based on information obtained from stored organizational data.

6. The computerized method of claim 1, further comprising:
determining that the stranger is external to an organization of the user; and
generating the contextualized summary of the stranger based on information obtained from an external source.

7. The computerized method of claim 1, further comprising:
generating a list of strangers to the user;
determining an appropriate format for a summary of the stranger for a target display application; and
generating the contextualized summary for each respective stranger in the determined appropriate format.

8. The computerized method of claim 7, further comprising:
determining the appropriate format based on an application whereby the contextualized summary is presented.

9. The computerized method of claim 1, further comprising:
detecting an upcoming interaction between the user and the stranger; and
based on the detected upcoming interaction, presenting the generated contextualized summary of the stranger to the user.

10. The computerized method of claim 1, further comprising:
detecting an interaction between the user and the stranger;
based on the detected interaction, presenting the generated contextualized summary of the stranger to the user.

11. The computerized method of claim 1, wherein presenting the contextualized summary further comprises:
presenting the contextualized summary in an enterprise application.

12. The computerized method of claim 1, further comprising:
identifying a decreasing trend in the generated familiarity score over time between the user and the individual; and
presenting a reconnection notification to the user, wherein the presented summary includes a link that, when selected, reconnect the user with the individual.

13. The computerized method of claim 12, wherein identifying the decreasing trend further comprises:
generating a relationship drop rate between the user and the individual;
determining the relationship drop rate is below a collaboration intensity threshold; and
based on the relationship drop rate being below the collaboration intensity threshold, determining the decreasing trend in the generated familiarity score.

14. The computerized method of claim 1, further comprising:
determining that the individual is known to the user based on the generated familiarity score; and
determining whether a next individual is another stranger to the user.

15. A system, comprising:
a memory;
a processor communicatively coupled to the memory; and
a contextualization service, implemented on the processor, that:
generates a familiarity score between a user and an individual;
determines the individual is a stranger to the user;
generates a contextualized summary of the stranger; and
sends, to a user interface (UI) for presentation, the generated contextualized summary of the stranger to the user in response to an upcoming interaction between the user and the stranger or a detected interaction between the user and the stranger.

16. The system of claim 15, wherein the contextualization service generates the familiarity score based on at least one of a number of interactions between the user and the individual, a length of time of the interactions between the user and the individual, an elapsed time since an initial interaction between the user and the individual, a type of the interactions between the user and the individual, a proximity between the user and the individual in an organization chart, and an amount of files shared between the user and the individual.

17. The system of claim 15, wherein the contextualization service determines the individual is the stranger to the user based on determining the generated familiarity score is below a familiarity score threshold.

18. The system of claim 15, wherein, to generate the contextualized summary of the stranger, the contextualization service further:
obtains data associated with the stranger;
filters the obtained data to generate insights about the stranger; and
generates a summary of the stranger, the summary including the generated insights.

19. The system of claim 15, wherein the contextualization service further:
responsive to determining the stranger is internal to an organization of the user, generates the contextualized summary of the stranger based on information obtained from stored organizational data; and
responsive to determining the stranger is external to the organization of the user, generates the contextualized summary of the stranger based on information obtained from an external source.

20. A computer-readable storage media storing instructions that, when executed by a processor, cause the processor to:
monitor interactions between a user and an individual;
generate a relationship drop rate between the user and the individual based on the monitored interactions;
determine the relationship drop rate is below a collaboration intensity threshold; and
control a user interface (UI) to present a reconnection notification to the user based on the relationship drop rate being below the collaboration intensity threshold, wherein the presented notification includes a link that, when selected, reconnect the user with the individual.
